(19) United States
(12) Patent Application Publication
(10) Pub. No.: US 2016/0104325 A1
(43) Pub. Date: Apr. 14, 2016

(54) CARPARK ACCESS MANAGEMENT SYSTEM AND PARKING LOT USING THE SAME

(71) Applicant: HON HAI PRECISION INDUSTRY CO., LTD., New Taipei (TW)

(72) Inventor: PEN-UEI LU, New Taipei (TW)

(21) Appl. No.: 14/716,383

(22) Filed: May 19, 2015

(30) Foreign Application Priority Data
Oct. 8, 2014 (TW) 103134981

(51) Int. Cl. G07B 15/02

(52) U.S. Cl. CPC G07B 15/02

(57) ABSTRACT

A parking lot can include an entrance, an exit, a plurality of parking spaces, and a carpark access management system including an entrance management module, a central control module, a management module, and an exit management module. The entrance management module can be configured to recognize a parking information of a car about to enter the parking lot. The central control module can be configured to control the entrance management module to permit or prevent the car to enter the parking lot. The management module can be configured to pay the parking fee automatically when the car leaves the parking lot, and deliver and transfer payment information to the central control module. The central control module can be configured to control the management module to permit the car to leave the parking lot in event that a driver of the car has finished payment.

### FIELD

The subject matter herein generally relates to carpark access management systems and parking lots using the same.

### BACKGROUND

A car should be parked in a parking lot when not in use. A carpark access management system should be used in the parking lot.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a diagrammatic view of an embodiment of a parking lot including a carpark access management system.

FIG. 2 is a block diagram of the carpark access management system of the parking lot of FIG. 1.

FIG. 3 is a flow chart of the carpark access management system of the parking lot of FIG. 1 describing a pre-enter method.

FIG. 4 is a parking flow chart of the carpark access management system of the parking lot of FIG. 1.

FIG. 5 is a flow chart of the carpark access management system of the parking lot of FIG. 1 describing a pre-exit method.

FIG. 6-7 are a flow chart of the carpark access management system of the parking lot of FIG. 1 describing an exit method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” when utilized, means “including, but not necessarily limited to”; it specifically indicates open-ended inclusion or membership in the so-described combination, group, series and the like.

The present disclosure is described in relation to carpark access management systems and parking lots having the carpark access management system.

A parking lot for receiving parked cars, can include an entrance, an exit, a plurality of parking space, and a carpark access management system. The a carpark access management system can include a central control module, an entrance management module positioned at the entrance, a management module positioned in the parking lot, and an exit management module positioned at the exit. The entrance management module can include an entrance monitor unit, and an entrance access control unit. The entrance monitor unit can be coupled to the central control module. The entrance monitor unit can be configured to recognize a license plate number of a car about to enter the parking lot, and to transfer the license plate number to the central control module. The entrance access control unit can be configured to permit the car to enter the parking lot, and configured to prevent the car from entering the parking lot. The management module can be coupled to the central control module. The management module can include a plurality of main monitor units positioned adjacent to the parking spaces respectively, and a plurality of payment units positioned in the parking lot. Each of the main monitor units can be configured to recognize a parking information about the license plate number of the car, a number of the parking space the car parking in, a real time the car starting to park, and a real time the car starting to leave, and configured to transfer the parking information to the central control module. The plurality of payment units can be configured to pay the parking fee automatically when the car leaves the parking lot, and deliver and transfer payment information to the central control module. The exit management module can be coupled to the central control module. The exit management module can include an exit monitor unit positioned at the exit, and an exit access control unit positioned at the exit. The exit monitor unit can be configured to recognize the license plate number of the car about to leave the parking lot, and to transfer the license plate number to the central control module. The central control module can be configured to search a retrieve payment information corresponding to the leaving car from the payment information sent by the payment unit, and to control the exit access control unit to permit the car to leave the parking lot in event that a driver of the car has finished payment.

A carpark access management system applied in a parking lot can include a central control module, an entrance management module, a management module coupled to the central control module, and an exit management module coupled to the central control module. The entrance management module can include an entrance monitor unit coupled to the central control module, and an entrance access control unit configured to permit the car to enter the parking lot, or prevent the car from entering the parking lot. The entrance monitor unit can be configured to recognize a license plate number of a car about to enter the parking lot, and to transfer the license plate number to the central control module. The management module can be coupled to the central control module. The management module can include a plurality of the main monitor units positioned in the parking lot, and a plurality of payment units positioned in the parking lot. Each of the main monitor units can be configured to recognize a parking information about the license plate number of the car, a real time the car starting to park, and a real time the car starting to leave, and configured to transfer the parking information to the central control module. The plurality of payment units can be configured to pay the parking fee automatically when the car leaves the parking lot, and deliver and transfer payment information to the central control module. The exit management module can be coupled to the central control module. The exit management module can include an exit monitor unit and an exit access control unit. The exit monitor unit can be configured to recognize a license plate number of the car about to leave the parking lot, and to transfer the license plate number to the central control module. The central control module can be configured to search a retrieve payment information corresponding to the leaving car from the payment information sent by the payment unit, and to control the exit access control unit to permit the car to leave the parking lot in event that a driver of the car has finished payment.

A carpark access management system applied in a parking lot can include a central control module, an entrance management module, an exit management module coupled to the central control module, and at least one payment unit coupled to the central control module. The entrance management module can include an entrance monitor unit coupled to the central control module, and an entrance access control unit configured to permit the car to enter the parking lot, or prevent the car from entering the parking lot. The entrance monitor unit can be configured to recognize a parking information about a license plate number of a car about to enter the parking lot, and a real time the car starting to park, and configured to transfer the parking information to the central control module. The exit management module can be coupled to the central control module. The exit management module can include an exit monitor unit and an exit access control unit. The exit monitor unit can be configured to recognize leaving information about the license plate number of the car about to leave the parking lot, and a real time the car intending to leave, and configured to transfer the leaving information to the central control module. The at least one payment unit can be configured to pay the parking fee automatically when the car leaves the parking lot, and deliver and transfer payment information to the central control module. The central control module can be configured to search a retrieve payment information corresponding to the leaving car from the payment information sent by the payment unit, and to control the exit access control unit to permit the car to leave the parking lot in event that a driver of the car has finished payment.

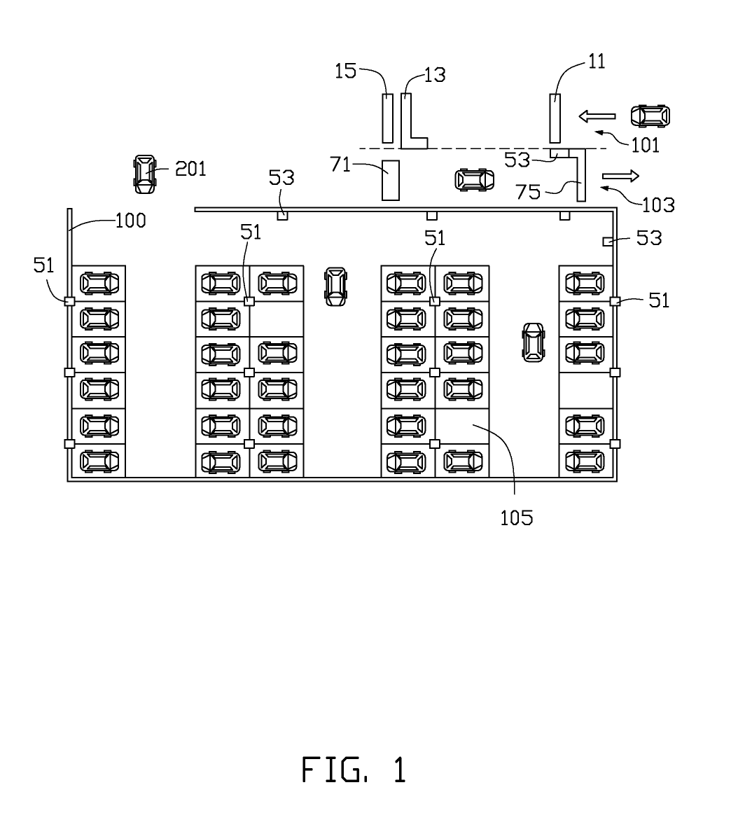

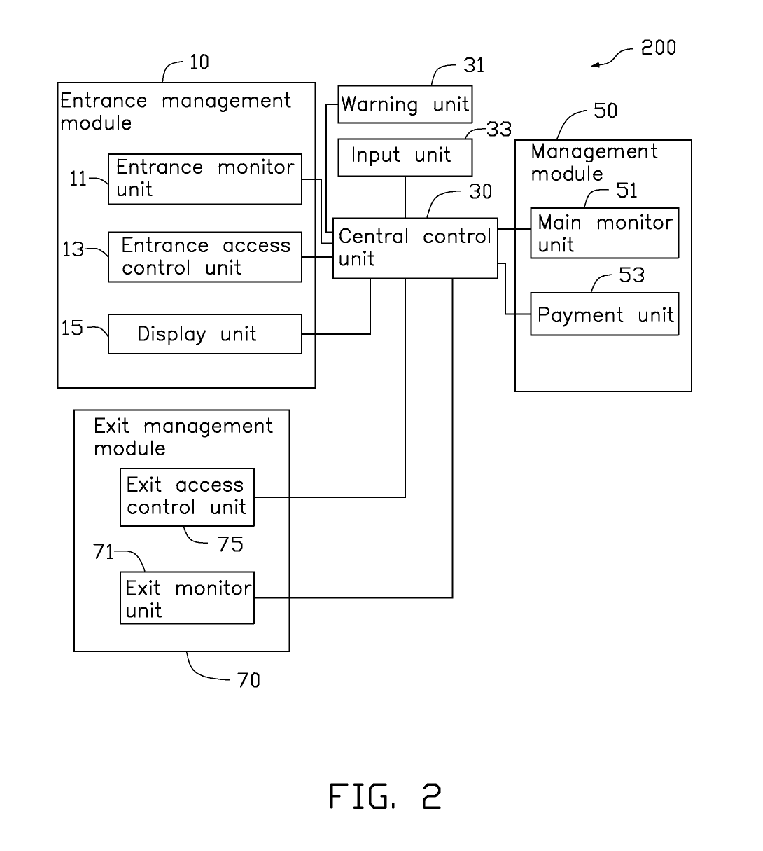

FIG. 1 illustrates an embodiment of a parking lot 100 having a carpark access management system 200 (shown in FIG. 2). The parking lot 100 can further include an entrance 101, an exit 103, and a plurality of parking places 105.

Referring to FIG. 2, the carpark access management system 200 can include an entrance management module 10 located at the entrance 101, a central control module 30 coupled to the entrance management module 10, a management module 50 located in the parking lot 100, and an exit management module 70 located at the exit 103.

The entrance management module 10 can include an entrance monitor unit 11, an entrance access control unit 13, and a display unit 15. The entrance monitor unit 11, the entrance access control unit 13, and the display unit 15 can be positioned adjacent to the entrance 101. The entrance monitor unit 11 can be configured to take a picture of a car 201 about to enter the parking lot 101, and to recognize a license plate number of the car 201 from the picture. The entrance access control unit 13 can be configured to permit the car 201 to enter the parking lot, or prevent the car 201 from entering the parking lot 100. The display unit 15 can be configured to display information of the car 201 about to enter the parking lot 100, and a number of empty parking spaces 105 in the parking lot 100.

In the illustrated embodiment, the entrance monitor unit 11 can be a camera.

The entrance monitor unit 11 can be configured to recognize the license plate number of the car 201 about to enter the parking lot 100, and transfer the license plate number to the central control module 30. In the illustrated embodiment, the display unit 15 can be a display screen. The display unit 15 can be configured to display the license plate number of the car 201 about to enter the parking lot 100, a real time when the car 201 pass the entrance 101, and the number of empty parking spaces 105 in the parking lot 100.

The central control module 30 can be electrically coupled to the entrance monitor unit 11 and the entrance access control unit 13. The carpark access management system 200 can further include a warning unit 31 and an input unit 33. The warning unit 31 and the input unit 33 can be electrically coupled to the central module 30, respectively. The central control module 30 can be configured to decide if the license plate number transferred by the entrance monitor unit 11 is recognizable and correct or not, and transfer the decision result to the entrance access control unit 13. In the illustrated embodiment, the central control module 30 can include a presetting program, and can be configured to decide if the license plate number is recognizable and correct or not via the presetting program.

The central control module 30 can be configured to store the license plate number when the license plate number is recognizable and correct, and control the entrance access control unit 13 to permit the car 201 to enter the parking lot 100. When the license plate number is not recognizable or correct, the central control module 30 can be configured to control the entrance access control unit 13 to prevent the car 201 from entering the parking lot 100. And the warning unit 31 can work to cause an attention of a staff on duty at the entrance 101. The staff can input a recognizable correct license plate number to the central control module 30 via the input unit 33. The central control module 30 can be configured to decide if the inputting license plate number is recognizable and correct or not again, and control the entrance access control unit 13 to permit the car 201 to enter the parking lot, or prevent the car 201 from entering according to decision result.

The central control module 30 can be configured to control the display unit 15 to display the license plate number of the car 201 and the real time after the entrance access control unit 13 permit the car 201 to enter the parking lot 100. The central control module 30 can be further configured to compute a number of empty parking spaces 105 in the parking lot 100, and transfer information of the number to the display unit 15. The display unit 15 can be configured to display the number of empty parking spaces 105 when receive the information.

The management module 50 can include a plurality of the main monitor units 51 and a plurality of payment units 53. The main monitor units 51 and the payment units 53 can be electrically coupled to the central control module 30.

The main monitor units 51 can be positioned adjacent to the parking spaces 105. In the illustrated embodiment, each of the main monitor unit 51 can be positioned between four parking spaces 105. In an alternative embodiment, one main monitor unit 51 can be positioned between three parking spaces 105. In other embodiment, one main monitor unit 51 can be positioned between two parking spaces 105, or one main monitor unit 51 can be positioned adjacent to one parking space 105. Each of the main monitor units 51 can be configured to recognize a license plate number of the car 201 about to park in the corresponding parking space 105. Each of the main monitor units 51 can be further configured to record a parking information such as a number of the corresponding parking space 105, a starting parking time of the car 201, and a leaving time of the car 201, and to transfer the parking information to the central control module 30.

At least one of the payment units 53 can be positioned at or adjacent to the exit 103, the rest of the payment units 53 can be positioned in the parking lot 100. The payment unit 52 can be configured to pay the parking fee automatically when the car 201 leaves the parking lot 100, and can be configured to display the payment amount and a number of the corresponding parking space 105 that the car 201 just leave.

When a car 201 is leaving a corresponding parking space 105, the corresponding main monitor unit 51 can be configured to transfer a leaving information about the leaving car 201 and the corresponding parking space 105 to the central control module 30. The leaving information can be such as, but not limited to, the license plate number of the leaving car 201, the real time when the car entering the parking lot 100, the number of the corresponding parking space 105, and the real time when the car 201 leaving the packing space 105. The central control module 30 can be configured to compute the total parking time of the leaving car 201 according to the leaving information. The central control module 30 can be further configured to compute a new number of empty parking spaces 105 according to the leaving information, and control the display unit 15 to update the number of empty parking spaces 105 on the display screen. In the illustrated embodiment, the main monitor unit 51 can be camera.

The central control module 30 can be configured to decide if the license plate number of the leaving car 201 is recognizable and correct or not from the information sent by the main monitor unit 51. If the license plate number of the leaving car 201 is recognizable and correct, and the central control module 30 can be further configured to store and transfer the license plate number, the number of the corresponding parking space 105, and the total parking time and the cost of the leaving car 201 to the payment unit 53. The payment unit 53 can be configured to receive the license plate number of the leaving car 201 when the car 201 arriving at the payment unit 53, and configured to display the number of the corresponding parking space 105 and the cost of the leaving car 201. The payment unit 53 can be further configured to deliver and transfer payment information to the central control module 30 after the leaving car 201 finish paying.

If the license plate number of the leaving car 201 is not recognizable or correct, the central control module 30 can be configured to control the warning unit 31 work to cause an attention of a staff on duty at the payment unit 53. The staff can input a recognizable correct license plate number to the central control module 30 via the input unit 33.

The exit management module 70 can include an exit monitor unit 71 and an exit access control unit 75, the exit monitor unit 71 and the exit access control unit 75 can be positioned at the exit 103, and electrically coupled to the central control module 30. The exit monitor unit 71 can be configured to take a picture of a car 201 about to leave the parking lot 101, and to recognize a license plate number of the car 201 from the picture. The exit access control unit 73 can be configured to permit the car 201 to leave the parking lot 100, or prevent the car 201 from leaving the parking lot 100.

The exit monitor unit 71 can be further configured to transfer the license plate number of the car 201 arriving at the exit 103 to the central control module 30. The central control module 30 can be configured to decide if the license plate number is recognizable and correct or not.

If the license plate number is recognizable and correct, the central control module 30 can be configured to search a retrieve payment information corresponding to the leaving car 201 from the information sent by the payment unit 53, and configured to control the exit access control unit 75 to permit the car 201 to leave the parking lot 100 when the central control module 30 confirms that the leaving car 201 has finished payment, or configured to control the exit access control unit 75 to prevent the car 201 from leaving when the central control module 30 confirms that the leaving car 201 did not finished payment. The leaving car 201 which did not pay can be required to finish payment at the payment unit 53 positioned at or adjacent to the exit 103. The payment unit 53 at or adjacent to the exit 103 can be configured to deliver and transfer payment information to the central control module 30 after the leaving car 201 finish paying. The central control module 30 can be configured to control the exit access control unit 75 to permit the car 201 to leave.

If the license plate number of the leaving car 201 is not recognizable or correct, the central control module 30 can be configured to control the warning unit 31 work to cause an attention of a staff. The staff can input a recognizable correct license plate number to the central control module 30 via the input unit 33. The central control module 30 can configured to decide if the inputting license plate number is recognizable and correct or not, and control the exit access control unit 75 to permit the car 201 to leave, or prevent the car 201 from leaving according to decision result.

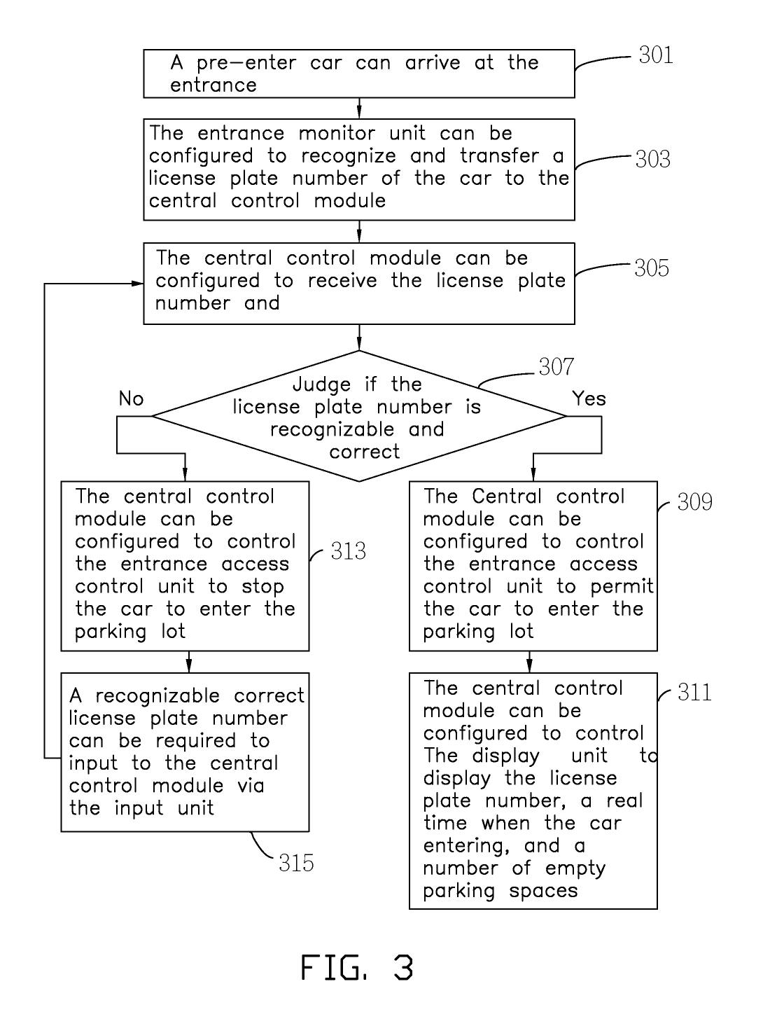

Referring to FIG. 3, FIG. 3 illustrates a flow chart of the carpark access management system 200 of the parking lot 100, describing a pre-enter method. The example method is provided by way of example, as there are a variety of ways to carry out the method. The method described below can be carried out using the carpark access management system 200 and the parking lot illustrated in FIGS. 1-2. The example method for pre-entering can begin at block 301.

At block 301, a pre-enter car can arrive at the entrance 101.

At block 303, the entrance monitor unit 11 can be started to recognize and transfer a license plate number of a pre-enter car 201 to the central control module 30.

At block 305, the central control module 30 can be configured to receive the license plate number and

At block 307, decide if the license plate number is recognizable and correct or not, and

At block 309, control the entrance access control unit 13 to permit the pre-enter car 201 to enter the parking lot 100 when the license plate number is recognizable and correct.

At block 311, the central control module 30 can be configured the control the display unit 15 to display the license plate number, a real time when the car entering, and a number of empty parking spaces.

At block 313, the central control module 30 can be configured to control the entrance access control unit 13 to prevent the pre-enter car 201 from entering, when the license plate number is not recognizable or correct.

At block 315, a recognizable correct license plate number can be required to input to the central control module 30 via the input unit 33.

The central control module 30 can be configured to decide if the inputting license plate number is recognizable and correct or not, and control the entrance access control unit 13 to permit the car 201 to enter, or prevent the car 201 from entering according to decision result, until the pre-enter car 201 is permitted to enter the parking lot 100.

The central control module 30 can be configured to record the real time when the car 201 entering the parking lot 100, and control the display unit 15 to display the license plate number of the car 201, the real entering time of the car 201, and the number of empty parking spaces 105 in the parking lot 100.

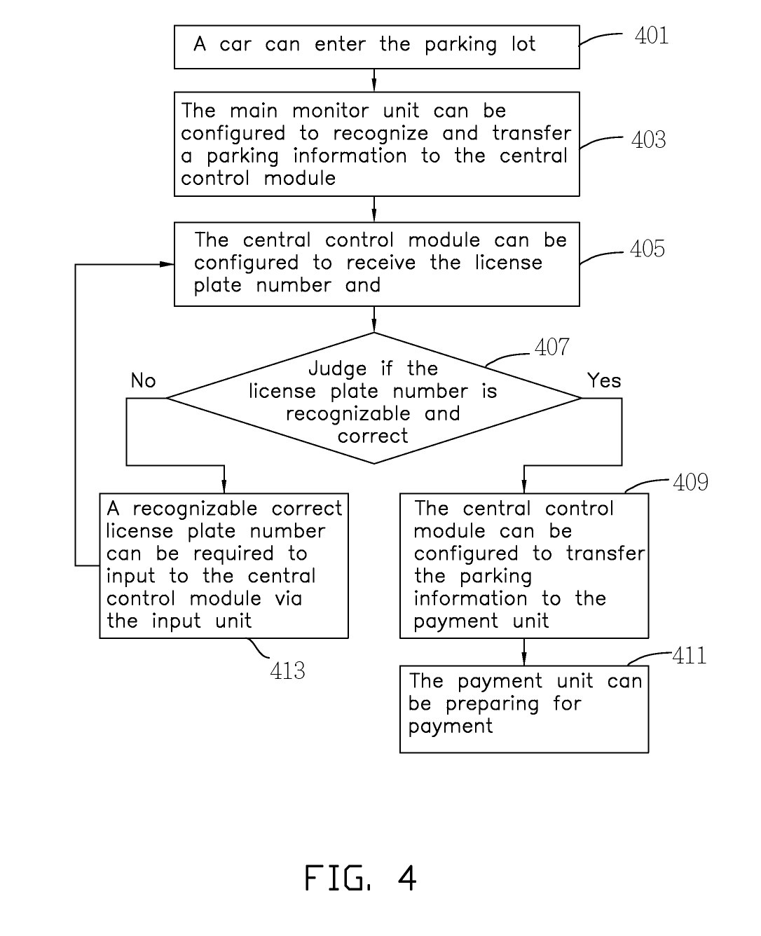

Referring to FIG. 4, FIG. 4 illustrates a flow chart of the carpark access management system 200 of the parking lot 100, describing a pre-parking method. The example method is provided by way of example, as there are a variety of ways to carry out the method. The method described below can be carried out using the carpark access management system 200 and the parking lot illustrated in FIGS. 1-2. The example method for pre-entering can begin at block 401.

At block 401, a car can enter the parking lot 100.

At block 403, the main monitor unit 51 can be configured to record and transfer a parking information such as, a license plate number of the car 201 about to park in the corresponding parking space 105, a number of the parking space 105, a starting parking time of the car 201 to the central control module 30.

At block 405, the central control module 30 can be configured to receive the license plate number, and

At block 407, decide if the license plate number is recognizable and correct or not, and store the information sent by the main monitor unit 51 when the license plate number is recognizable and correct.

At block 409, the central control module 30 can be configured the transfer the parking information to the payment unit 53.

At block 411, the payment unit 53 can be preparing for payment.

At block 413, a recognizable correct license plate number can be required to input to the central control module 30 via the input unit 33, when the license plate number is not recognizable or correct. The central control module 30 can be configured to decide if the inputting license plate number is recognizable and correct or not, and store the information according to the decision result.

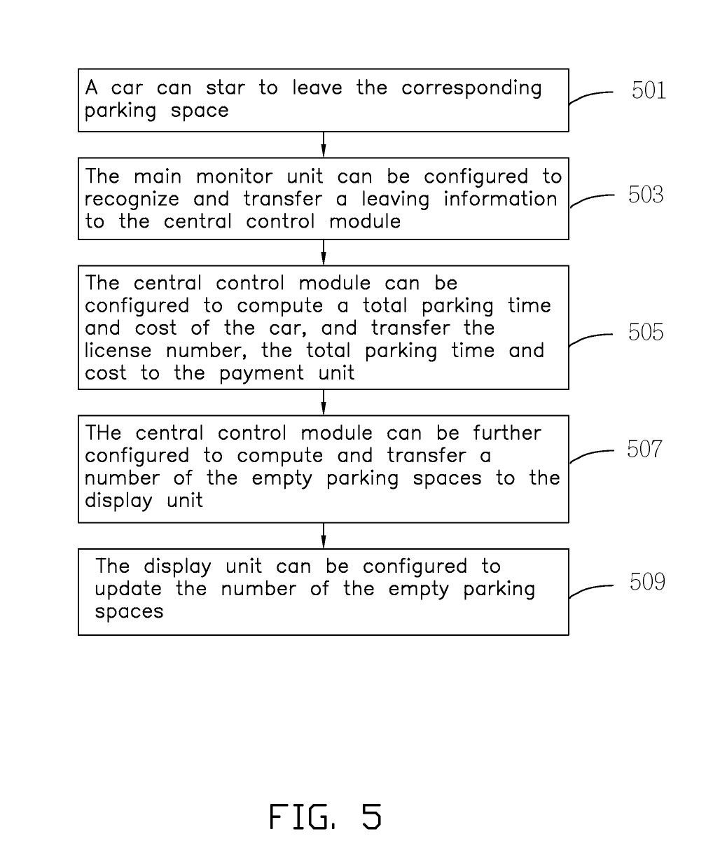

Referring to FIG. 5, FIG. 5 illustrates a flow chart of the carpark access management system 200 of the parking lot 100, describing a pre-exit method. The example method is provided by way of example, as there are a variety of ways to carry out the method. The method described below can be carried out using the carpark access management system 200 and the parking lot illustrated in FIGS. 1-2. The example method for pre-exit can begin at block 501.

At block 501, a car 201 can start to leave the corresponding parking space 105.

At block 503, the corresponding main monitor unit 51 can be configured to transfer a leaving information about the leaving car 201 and the number of the corresponding parking space 105 to the central control module 30, when a car 201 is leaving a corresponding parking space 105. The leaving information can be such as, but not limited to, the license plate number of the leaving car 201, the number of the corresponding parking space 105, the real time when the car parking in the corresponding parking space 105, and the real time when the car 201 leaving the packing space 105.

At block 505, the central control module 30 can be configured to compute a total parking time and cost of the leaving car 201 according to the information, and transfer license plate number, the total parking time and cost to the payment unit 53.

At block 507, the central control module 30 can be further configured to compute a new number of empty parking spaces 105 according to the information, and control the display unit 15 to update the number of empty parking spaces 105 on the display screen.

At block 509, the display unit 15 can be configured to update the number of empty parking spaces 105 on the display screen.

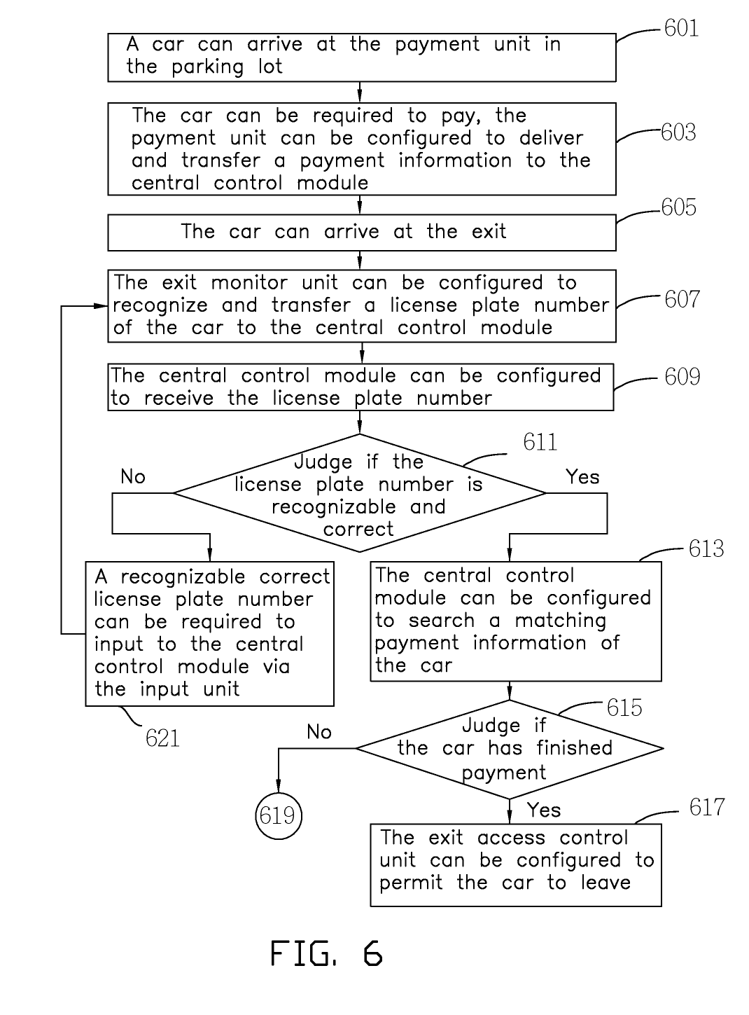

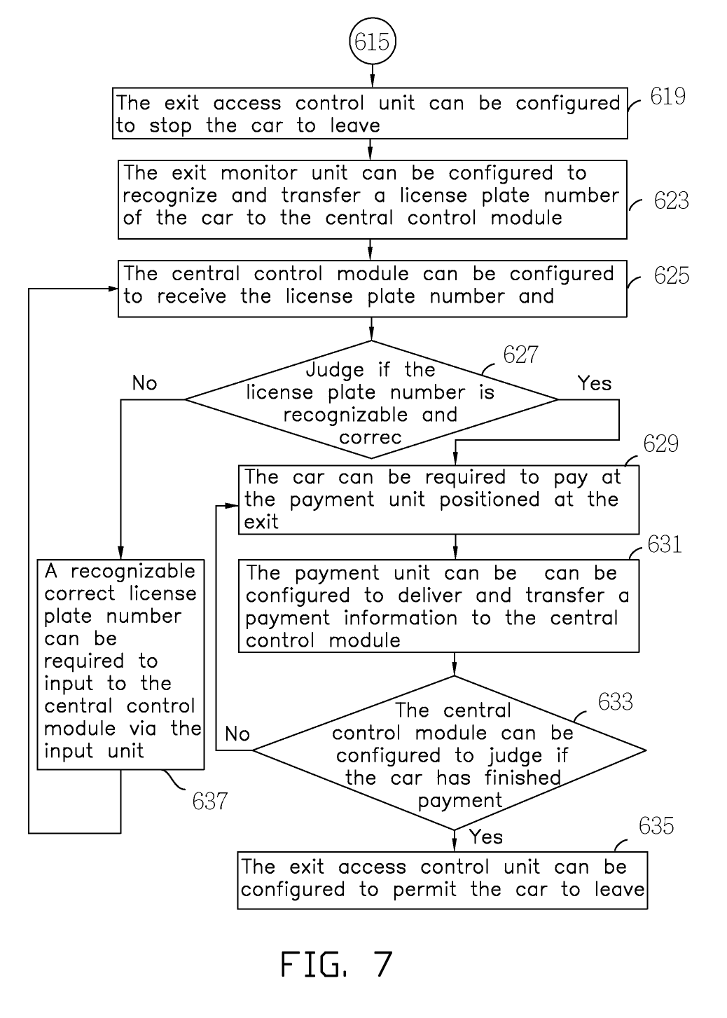

Referring to FIGS. 6-7, FIGS. 6-7 illustrate a flow chart of the carpark access management system 200 of the parking lot 100, describing an exit method. The example method is provided by way of example, as there are a variety of ways to carry out the method. The method described below can be carried out using the carpark access management system 200 and the parking lot illustrated in FIGS. 1-2. The example method for pre-entering can begin at block 601.

At block 601, a car 201 can arrive at the payment unit 53.

At block 603, the payment unit 53 can be configured to display the license plate number, the number of the corresponding parking space 105, and the total parking time and cost of the car 201, and deliver and transfer payment information to the central control module 30 after the car 201 finish paying.

At block 605, the car 201 is leaving and arrive at the exit 103.

At block 607, the exit monitor unit 71 can be configured to recognize and transfer a license plate number of the car 201 to the central control module 30.

At block 609, the central control module 30 can be configured to receive the license plate number and

At block 611, decide if the license plate number is recognizable and correct or not.

At block 613, if the license plate number is recognizable and correct, the central control module 30 can be configured to search a matching payment information corresponding to the leaving car 201 from the information sent by the payment unit 53.

At block 615, the central control module 30 can be configured to decide if a driver of the car 201 has finish payment.

At block 617, the central control module 30 can be configured to control the exit access control unit 75 to permit the car 201 to leave the parking lot 100 when the central control module 30 confirms that a driver of the car 201 has finished payment, or

At block 619, configured to control the exit access control unit 75 to prevent the car 201 from leaving when the central control module 30 confirms that a driver of the car 201 did not finished payment.

At block 621, if the license plate number of the leaving car 201 is not recognizable or correct, a recognizable correct license plate number is required to input to the central control module 30 via the input unit 33. The central control module 30 can configured to decide if the inputting license plate number is recognizable and correct or not, and control the exit access control unit 75 to permit the car 201 to leave, or prevent the car 201 from leaving according to decision result.

At block 619, a car 201 which did not pay can be required to finish payment at the payment unit 53 positioned at or adjacent to the exit 103. The central control module 30 can be configured to control the exit access control unit 75 to prevent the car 201 from leaving.

At block 623, the exit monitor unit 71 can be configured to recognize and transfer a license plate number of the car 201 to the central control module 30.

At block 625, the central control module 30 can be configured to receive the license plate number and

At block 627, decide if the license plate number is recognizable and correct or not.

At block 629, if the license plate number is recognizable and correct, the central control module 30 can be configured to transfer the license plate number to the payment unit 53 positioned at or adjacent to the exit 103. The car 201 can be required to finish payment at the payment unit 53.

At block 631, the payment unit 53 at or adjacent to the exit 103 can be configured to deliver and transfer payment information to the central control module 30.

At block 633, the central control module 30 can be configured to decide if a driver of the car has finished payment.

At block 635, the central control module 30 can be configured to control the exit access control unit 75 to permit the car 201 to leave, in event that a driver of the car 201 has finished payment.

At block 637, if the license plate number of the leaving car 201 is not recognizable or correct, a recognizable correct license plate number can be required to input to the central control module 30 via the input unit 33. The central control module 30 can configured to decide if the inputting license plate number is recognizable and correct or not. The central control module 30 can be further configured to transfer the license plate number to the payment unit 53 positioned adjacent to the exit according to decision result, and control the exit access control unit 75 to permit the car 201 to leave, or prevent the car 201 from leaving according to payment result.

In the illustrated embodiment, the total parking time of a car 201 can be computed according the real time the car 201 starting to park in a corresponding parking space 105 and the real time the car starting to leave the corresponding parking space 105. In an alternative embodiment, the total parking time of a car 201 can be computed according the real time the car 201 starting to enter the parking lot 100 and the real time the car starting to leave the corresponding parking space 105. In other embodiment, the total parking time of a car 201 can be computed according the real time the car 201 starting to enter the parking lot 100 and the real time the car starting to leave the exit 103.

In an alternative embodiment, the main monitor units 51 can be omitted. Such that the entrance monitor unit 11 can be configured to recognize a parking information about the license plate number of the car 201, and a real time the car 201 entering the parking lot 100, and configured to transfer the parking information to the central control module 30. The exit monitor unit 71 can be configured to recognize a leaving information about the license plate number of the car 201, and a real time the car 201 leaving the parking lot 100, and configured to transfer the leaving information to the central control module 30. There by the central control module 30 can be configured to compute the number of empty parking spaces 105 in the parking lot 100, and the total parking time and cost of the car 201.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure, as defined by the appended claims.

What is claimed is:

1. A parking lot for receiving parked cars, the parking lot comprising:
an entrance;
an exit;
a plurality of parking spaces; and
a carpark access management system comprising:
a central control module;
an entrance management module positioned at the entrance; the entrance management module comprising:
an entrance monitor unit coupled to the central control module, the entrance monitor unit configured to recognize a license plate number of a car about to enter the parking lot, and to transfer the license plate number to the central control module;
an entrance access control unit configured to permit the car to enter the parking lot, and configured to prevent the car from entering the parking lot;
a management module positioned in the parking lot, and coupled to the central control module, the management module comprising:
a plurality of main monitor units positioned adjacent to the parking spaces respectively, each of the main monitor units configured to recognize a parking information about the license plate number of the car, a number of the parking space the car parking in, a real time the car starting to park, and a real time the car starting to leave; and configured to transfer the parking information to the central control module; and
a plurality of payment units positioned in the parking lot, configured to pay the parking fee automatically when the car leaves the parking lot, and deliver and transfer payment information to the central control module; and
an exit management module positioned at the exit, and coupled to the central control module, the exit management module comprising:
an exit monitor unit positioned at the exit, configured to recognize a license plate number of the car about to leave the parking lot, and to transfer the license plate number to the central control module; and
an exit access control unit positioned at the exit,
wherein the central control module is configured to search retrieve payment information corresponding to the leaving car from the payment information sent by the payment unit, and to control the exit access control unit to permit the car to leave the parking lot in event that a driver of the car has finished payment.

2. The parking lot of claim 1, wherein the central control module is configured to decide if the license plate number sent by the entrance monitor unit is recognizable and correct or not, and control the entrance access control unit to permit the car to enter the parking lot, or prevent the car from entering the parking lot according to decision result.

3. The parking lot of claim 2, wherein the central control module is configured to decide if the license plate number sent by the main monitor unit is recognizable and correct or not, and transfer the license plate number to the payment unit if the license plate number is recognizable and correct; the central control module is further configured to search a retrieve payment information corresponding to the leaving car from the payment information sent by the payment unit.

4. The parking lot of claim 2, wherein the carpark access management system further comprises a warning unit coupled to the central control module; the central control module is configured to control the warning unit to work if the license plate number sent by the main monitor unit is not recognizable or correct, and control the entrance access control unit to prevent the car from entering the parking lot.

5. The parking lot of claim 4, wherein the carpark access management system further comprises an input unit coupled to the central control module; when the license plate number sent by the main monitor unit is not recognizable or correct, a recognizable correct license plate number is required to input to the central control module via the input unit.

6. The parking lot of claim 1, wherein the central control module is configured to compute the total parking time and cost of the leaving car according to the parking information sent by the main monitor unit, and control the payment unit to display the license plate number, the total parking time and cost of the leaving car.

7. The parking lot of claim 6, wherein the entrance management module further comprises a display unit positioned at the entrance; the display unit is configured to display the license plate number of the car entering the parking lot.

8. The parking lot of claim 7, wherein the central control module is further configured to compute a number of empty parking spaces according to the parking information sent by the main monitor units, and control the display unit to display the number of empty parking spaces.

9. The parking lot of claim 1, wherein at least one of the payment units is positioned at the exit; the central control unit is configured to control the exit access control unit to prevent the car from leaving the parking lot in event that a driver of the car did not pay, and the driver of the car is require to finish paying on the payment units at the exit.

10. A carpark access management system applied in a parking lot, the carpark access management system comprising:
a central control module;
an entrance management module comprising:
an entrance monitor unit coupled to the central control module; the entrance monitor unit configured to recognize a license plate number of a car about to enter the parking lot, and to transfer the license plate number to the central control module;
an entrance access control unit configured to permit the car to enter the parking lot, and configured to prevent the car from entering the parking lot;
a management module coupled to the central control module; the management module comprising:
a plurality of the main monitor units positioned in the parking lot, each of the main monitor units configured to recognize a parking information about the license plate number of the car, a real time the car starting to park, and a real time the car starting to leave, and configured to transfer the parking information to the central control module; and
a plurality of payment units configured to pay the parking fee automatically when the car leaves the parking lot, and configured to deliver and transfer payment information to the central control module; and
an exit management module coupled to the central control module, the exit management module comprising:
an exit monitor unit configured to recognize a license plate number of the car about to leave the parking lot, and to transfer the license plate number to the central control module; and
an exit access control unit coupled to the central control module;
wherein, the central control module is configured to search a retrieve payment information corresponding to the leaving car from the payment information sent by the payment unit, and to control the exit access control unit to permit the car to leave the parking lot in event that a driver of the car has finished payment.

11. The carpark access management system of claim 10, wherein the central control module is configured to decide if the license plate number sent by the entrance monitor unit is recognizable and correct or not, and control the entrance access control unit to permit the car to enter the parking lot, or prevent the car from entering the parking lot according to decision result.

12. The carpark access management system of claim 11, wherein the central control module is configured to decide if the license plate number sent by the main monitor unit is recognizable and correct or not, and transfer the license plate number to the payment unit if the license plate number is recognizable and correct; the central control module is further configured to search a retrieve payment information corresponding to the leaving car from the payment information sent by the payment unit.

13. The carpark access management system of claim 11, wherein the carpark access management system further comprises a warning unit coupled to the central control module; the central control module is configured to control the warning unit to work if the license plate number sent by the main monitor unit is not recognizable or correct, and control the entrance access control unit to prevent the car from entering the parking lot.

14. The carpark access management system of claim 13, wherein the carpark access management system further comprises an input unit coupled to the central control module; when the license plate number sent by the main monitor unit is not recognizable or correct, a recognizable correct license plate number is required to input to the central control module via the input unit.

15. The carpark access management system of claim 10, wherein the central control module is configured to compute the total parking time and cost of the leaving car according to the parking information sent by the main monitor unit, and control the payment unit to display the license plate number, the total parking time and cost of the leaving car.

16. The carpark access management system of claim 15, wherein the entrance management module further comprises a display unit coupled to the central control module; the display unit is configured to display the license plate number of the car entering the parking lot.

17. The carpark access management system of claim 16, wherein the central control module is further configured to compute a number of empty parking spaces in the parking lot according to the parking information sent by the main monitor units, and control the display unit to display the number of empty parking spaces.

18. A carpark access management system applied in a parking lot, the carpark access management system comprising:
a central control module;
an entrance management module comprising:
an entrance monitor unit coupled to the central control module; the entrance monitor unit configured to recognize a parking information about a license plate number of a car about to enter the parking lot, a real time the car starting to park, and configured to transfer the parking information to the central control module;
an entrance access control unit configured to permit the car to enter the parking lot, and configured to prevent the car from entering the parking lot;
an exit management module coupled to the central control module; the exit management module comprising:
an exit monitor unit configured to recognize leaving information about the license plate number of the car about to leave the parking lot, a real time the car intending to leave, and configured to transfer the leaving information to the central control module; and
an exit access control unit coupled to the central control module; and
at least one payment unit configured to pay the parking fee automatically when the car leaves the parking lot, and configured to deliver and transfer payment information to the central control module;
wherein, the central control module is configured to search a retrieve payment information corresponding to the leaving car from the payment information sent by the payment unit, and to control the exit access control unit to permit the car to leave the parking lot in event that a driver of the car has finished payment.

19. The carpark access management system of claim 18, wherein the central control module is configured to decide if the license plate number sent by the entrance monitor unit is recognizable and correct or not, and control the entrance access control unit to permit the car to enter the parking lot, or prevent the car from entering the parking lot according to decision result.

20. The carpark access management system of claim 19, wherein the central control module is configured to decide if the license plate number sent by the main monitor unit is recognizable and correct or not, and transfer the license plate number to the payment unit if the license plate number is recognizable and correct; the central control module is further configured to search a retrieve payment information corresponding to the leaving car from the payment information sent by the payment unit.
